(19) United States
(12) Patent Application Publication
(10) Pub. No.: US 2006/0122451 A1
(43) Pub. Date: Jun. 8, 2006

(54) Binding and in situ destruction of chemical agents and other contaminants

(76) Inventor: Viktor I. Petrik, Moscow (RU)

Correspondence Address: ROBERT D. FISH;RUTAN & TUCKER LLP, 611 ANTON BLVD 14TH FLOOR, COSTA MESA, CA, 92626-1931, US

(21) Appl. No.: 11/007,612

(22) Filed: Dec. 7, 2004

(51) Int. Cl. A62D 3/00

(52) U.S. Cl. 588/301

(57) ABSTRACT

A graphene-containing composition is employed to bind a contaminant, which is then destroyed in situ using microwave irradiation. In preferred aspects of the inventive subject matter, the microwave irradiation has a frequency and energy sufficient to cause electron emission from the graphene.

### FIELD OF THE INVENTION

The field of the invention is capture and destruction of various toxic compounds, and especially chemical agents.

### BACKGROUND OF THE INVENTION

Toxic compounds, and especially volatile toxic compounds and toxic compounds in gases (e.g., flue gas) are often difficult to safely dispose of due to their relatively low concentration in the gaseous medium and/or their extreme toxicity. While various methods for destruction of such compounds have been developed, various difficulties nevertheless remain.

In one example, chemical agents can be incinerated using a high-temperature furnace, plasma torch, or molten metal scrubber. While such technologies have the potential for complete destruction of diverse compounds in one apparatus, various difficulties remain. Among other things, high-temperature methods place severe demands on the materials of construction. Still further, the combustion process must be tightly controlled to avoid inadvertent release of the compounds into the atmosphere. Alternatively, compounds may be reduced in a hydrogenation reactor at relatively low pressure (typically at about 1 bar) with hydrogen in molar excess at elevated temperatures (e.g., between 800° C. and 1200° C.). Reduction of compounds is relatively fast (occurs typically within seconds), and can be readily adapted to various compounds. However, new toxic byproducts (e.g., H₂S) can be formed. Moreover, handling of hydrogen imposes additional safety concerns and can therefore only be safely performed by highly skilled personnel.

In further known processes, compounds can be destroyed in a supercritical water and wet air oxidation process, or by employing dry HCl gas, and/or pyrolysis. Such processes are typically less common and tend to either form new toxic compounds, and/or require substantial technical complex equipment.

In yet other examples, toxic compounds can be reacted with a reagent to produce a modified and less toxic compound, which is then immobilized in a composition to form a solid phase. Among other options, G-agents (e.g. sarin, soman) are combined with monoethanolamine and water to form a derivative that is then admixed with calcium hydroxide and bitumen. Similarly V-agents (e.g., Vx) can be treated with an inactivation mixture known as RD-4, to which bitumen is added to form a relatively low toxicity bitumenized product. While such derivatization and immobilization is a conceptually relatively simple process, the amount of waste generated during the destruction of such compounds is typically between 3 to 7 times the original amount of the compound.

In still further known examples, adsorbents are employed to bind toxic compounds, and most typically, the adsorbent is a high-surface porous carbon-based material such as activated charcoal as described in U.S. Pat. No. 6,419,799 to Cha. Desorption of the toxic compounds is then effected by microwaves and the compounds are then fed to an oxidation catalyst bed that is further irradiated with microwaves to catalytically destroy the toxic compounds. Alternatively, microwave-assisted pyrolysis may be used as taught by Dauermann in U.S. Pat. No. 5,698,762 in which polyaromatic hydrocarbons are irradiated with microwaves under a bed of sand, which may further include activated charcoal as a microwave susceptor. In other configurations (see e.g., U.S. Pat. No. 5,540,886 to Warmbier et al.), certain toxic compounds in a combustion gas are passed through a bed of activated charcoal that operates as a microwave susceptor to generate heat and thereby thermally degrade the toxic compounds.

In yet another approach using microwave irradiation, iron powders are employed as an electron source to provide the electrons for a reaction in which a carbon-halogen bond is broken as described in U.S. Pat. No. 4,345,983. While currently known microwave assisted processes have several advantages over other decontamination processes, various difficulties nevertheless remain. Among other things, where porous activated charcoal is employed as a sorbent and microwave susceptor, the contaminant tends to be driven off the charcoal before decomposition temperature is achieved. Thus, binding and heat generation are competing processes to at least some degree. Moreover, due to the relatively high degree of porosity in activated charcoal, complete removal and/or destruction is often not achieved and toxic side products are generated.

Therefore, while various materials and methods for destruction of chemical agents are known in the art, all or almost all of them suffer from one or more disadvantages. Thus, there is still a need to provide improved compositions and methods for destruction of chemical agents.

### SUMMARY OF THE INVENTION

The present invention is directed to compositions and methods for destruction of various contaminants, and especially chemical agents, using a graphene-containing composition that binds the contaminant and that is irradiated with electromagnetic radiation, preferably at a frequency and energy sufficient to induce electron emission from the graphene.

In one aspect of the inventive subject matter, a reactor comprises a microwave transmitter that is coupled to a reaction space such that microwave radiation from the microwave transmitter is delivered to the reaction space. The reactor further includes a composition comprising at least 10 wt % graphene, wherein the contaminant is bound to the composition, and wherein the composition is disposed within the reaction space. Especially preferred reactors are operated using continuous flow of contaminated gaseous medium that is typically fed into the reactor using an inlet and released (and most typically depleted of the contaminant) from the reactor using an outlet.

Consequently, contemplated compositions include those comprising graphene (e.g., at least 10 wt % graphene) and may further include a chemical agent at a weight that is at least equal to the weight of the composition. The composition may also be associated with an information that informs a person that the composition binds a chemical agent, and that microwave irradiation of the composition destroys the chemical agent. Especially contemplated contaminants include chemical agents (e.g., soman, sarin, Vx, lewisite, and mustard gas), an optionally substituted hydrocarbon (e.g., halogenated VOCs), and/or an optionally substituted polycyclic aromatic compound (e.g., various dioxins, PHBs, etc.).

Therefore, a method of destroying a contaminant may include a step of binding the contaminant to a composition that includes at least 10 wt % graphene, and another step of irradiating the composition with electromagnetic wave energy at a dose and wavelength effective to destroy the contaminant.

Various objects, features, aspects and advantages of the present invention will become more apparent from the following detailed description of preferred embodiments of the invention.

### BRIEF DESCRIPTION OF THE DRAWING

FIG. 1 is an exemplary configuration of a device for destruction of chemical agents according to the inventive subject matter.

FIG. 2A is an exemplary electronmicrograph depicting a composition according to the inventive subject matter.

FIG. 2B is a detail view of the composition of FIG. 2A at a higher magnification.

### DETAILED DESCRIPTION

The inventors have surprisingly discovered that a graphene-containing composition can be effectively employed as a sorbent for numerous contaminants, wherein the contaminant is destroyed in the composition using microwave irradiation. While not wishing to be bound by any theory or hypothesis, the inventors contemplate that the microwave-mediated destruction is at least in part due to electron field emission of the graphene.

As used herein, the term “graphene” refers to a molecule in which a plurality of carbon atoms (e.g., in the form of five-membered rings, six-membered rings, and/or seven-membered rings) are covalently bound to each other to form a (typically sheet-like) polycyclic aromatic molecule. Consequently, and at least from one perspective, a graphene may be viewed as a single layer of carbon atoms that are covalently bound to each other (most typically sp² bonded). It should be noted that such sheets may have various configurations, and that the particular configuration will depend (among other things) on the amount and position of five-membered and/or seven-membered rings in the sheet. For example, an otherwise planar graphene sheet consisting of six-membered rings will warp into a cone shape if a five-membered ring is present the plane, or will warp into a saddle shape if a seven-membered ring is present in the sheet. Furthermore, and especially where the sheet-like graphene is relatively large, it should be recognized that the graphene may have the electron-microscopic appearance of a wrinkled sheet. It should be further noted that under the scope of this definition, the term “graphene” also includes molecules in which several (e.g., two, three, four, five to ten, one to twenty, one to fifty, or one to hundred) single layers of carbon atoms (supra) are stacked on top of each other to a maximum thickness of less than 100 nanometers. Consequently, the term “graphene” as used herein refers to a single layer of aromatic polycyclic carbon as well as to a plurality of such layers having a thickness of less than 100 nanometers. Typically, the dangling bonds on the edge of the graphene are saturated with a hydrogen atom.

As further used herein, the term “carbon nanotube” refers to a cylindrical single- or multi-walled structure in which the wall(s) is (are) predominantly composed of carbon, wherein the diameter may be uniform or decreasing over the length of the nanotube. In some instances, the carbon nanotube can be curved, and is therefore also termed “carbon nanohom”.

As also used herein, the term “contaminant” refers to any compound and/or mixture of compounds that is considered undesirable and/or detrimental to the medium in which the compound and/or mixture of compounds is disposed, and/or a person that is exposed to the medium. Thus, contaminants that are particularly contemplated under this definition include various chemical agents (i.e., a chemical substance that is intended for use in military operations to kill, seriously injure, or incapacitate people through physiological effects. For example, chemical agents include blood, nerve, choking, blister, and incapacitating agents) and various optionally substituted hydrocarbons which may be present in a gaseous medium (e.g., ambient air, process air) or a liquid medium (e.g., water). Particularly contemplated contaminants include sarin, soman, Vx, mustard gas, lewisite, various halogenated hydrocarbons, and optionally substituted polycyclic aromatic compounds.

As yet further used herein, the term “non-porous” in conjunction with a material refers to a porosity (i.e., void space within the material itself) of the material of less than 5 vol %, and even more typically of less than 2 vol %. For example, a material having a total volume of 10 cubic micrometer is considered non-porous is that material has a total pore volume of less than 0.5 cubic micrometer. It should be noted that the annular space defined by a carbocyclic ring is not considered a pore under the definition provided herein. Also, where a material has a contorted shape (e.g., a graphene in a wrinkled, sheet-like configuration) within a given volume, the void space between the material in that volume is not considered a pore under the definition provided herein. It should be especially recognized that the non-porous surface of graphene and other nanostructured materials (e.g., single and multi-walled carbon nanotubes, carbon nanoonions, etc.) effectively bind in typically non-covalent manner numerous contaminants, and especially various optionally substituted hydrocarbons and chemical agents from a variety of liquid and/or gaseous media. Viewed from another perspective, the non-porous surfaces of graphene with a generally flat configuration (i.e., materials in which the first and second dimensions are substantially larger [e.g., at least 1000-fold] than the third dimension) are particularly effective in binding such contaminants, and have in most cases a smallest dimension of less than 500 nm, more typically of less than 300 nm, even more typically of less than 200 nm, and most typically of less than 100 nm.

In one preferred aspect of the inventive subject matter, the inventors discovered graphene in a graphene-containing composition will effectively bind numerous contaminants, and that the so bound contaminants can be destroyed by irradiation of the graphene-containing composition with microwave radiation. More specifically, and in one exemplary use, the inventors discovered that 10 grams of a graphene-containing composition with a graphene content of at least 80 wt % absorbs about 350 grams of the chemical agent sarin. When the so loaded graphene-containing composition was placed in a hermetically sealed ceramic containment and irradiated for about 5 minutes with microwave radiation having a frequency of about 2.45 GHz and energy of 12 kW, the sarin amount in the graphene-containing composition fell below detectable limits.

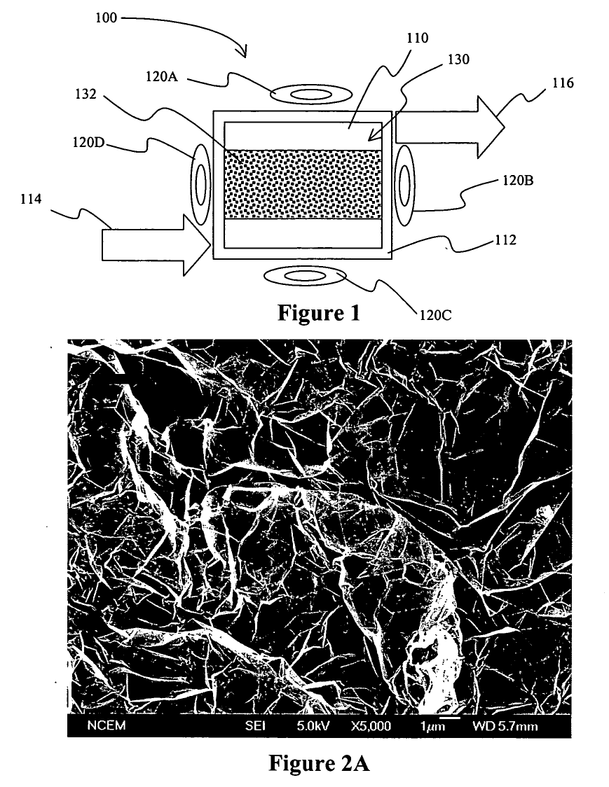

An exemplary device for the destruction of a (preferably graphene-bound) contaminant is depicted in FIG. 1 in which device 100 has a reaction chamber 110 that is surrounded by heat-insulating ceramic walls 112. Magnetrons 120A-120D (control circuitry not shown) are coupled to the device such that the microwave energy is directed into the reaction chamber 110 in which the graphene-containing composition 132 is disposed to which the chemical agent (not shown) is bound. The graphene-containing composition 132 is typically retained in a filter element 130. Where desirable, the reaction chamber 110 is coupled to an inlet 114 and an outlet 116 such that the graphene-containing composition 132 is upstream of the inlet 114 and downstream of the outlet 116. It should be recognized that in such configurations, continuous operation is possible in which gaseous medium containing the contaminant enters the reaction space through the inlet and in which that gaseous medium after irradiation and depleted of the contaminant exits the reaction space through the outlet.

With respect to suitable graphene-containing compositions, it is generally preferred that contemplated graphene-containing compositions include graphene in an amount of at least 5 wt %, more typically at least 10 wt %, even more typically at least 20 wt %, and most typically at least 50 wt %. Particularly preferred compositions will have between about 80 wt % to about 95 wt % graphene, and may also include carbon nanotubes and/or other carbon-based nanostructures. It is still further preferred that the graphene-containing composition is a carbonaceous material fabricated from commercially available starting materials, including coal, tar, coke, graphite, carbonized organic matter, and/or carbonized synthetic fibers. Suitable starting materials also include various synthetic compounds, and especially synthetic (preferably polycyclic) aromatic compounds.

Contemplated starting materials or graphene may also be derivatized with one or more heteroatoms (e.g., optionally substituted nitrogen, oxygen, sulfur, etc.) and/or substituents. The term “substituted” as used herein also refers to a replacement of a chemical group or substituent (e.g., hydrogen) with a functional group, and particularly contemplated functional groups include nucleophilic (e.g., —NH₂, —OH, —SH, —NC, etc.) and electrophilic groups (e.g., C(O)OR, C(X)OH, etc.), polar groups (e.g., —OH), non-polar groups (e.g., aryl, alkyl, alkenyl, alkynyl, etc.), ionic groups (e.g., —NH₃⁺), halogens (e.g., —F, —Cl), and all chemically reasonable combinations thereof. Thus, the term “substituent” includes nucleophilic (e.g., —NH₂, —OH, —SH, —NC, etc.) and electrophilic groups (e.g., C(O)OR, C(X)OH, etc.), polar groups (e.g., —OH), non-polar groups (e.g., aryl, alkyl, alkenyl, alkynyl, etc.), ionic groups (e.g., —NH₃⁺), halogens (e.g., —F, —Cl), and all chemically reasonable combinations thereof.

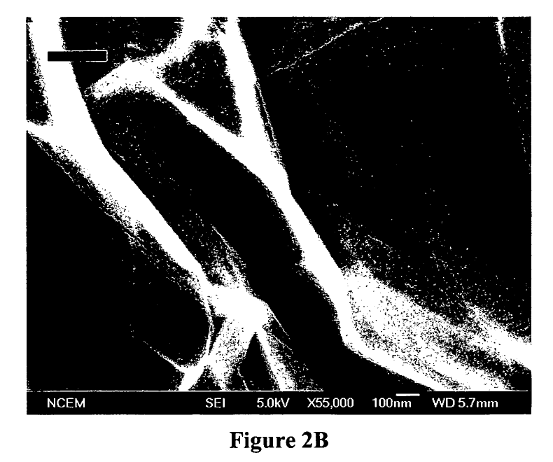

Surprisingly, the inventors discovered that a reagent for carbon-carbon bond cleavage reactions can be employed to form from starting materials contemplated above a graphene-containing composition that includes graphene with a thickness of typically less than 100 nm, more typically with a thickness of 1 to 1000 layers, and most typically with a thickness of 1 to 100 layers of aromatic polycyclic carbon. In most preferred aspects, such reagents were used to produce the graphene-containing composition from graphite. There are numerous carbon-carbon bond cleavage reagents known in the art, and all of them are considered suitable for use herein. However, particularly preferred reagents include commercially available activated acid catalysts (e.g., Catalog Item: Activated Acid Catalyst #3 (plasma-activated hydrochloric acid) by SupraCarbonic, LLC., 348 N. Eckhoff Street—Orange, Calif. 92868, USA; www.supracarbonic.com/products/). Exemplary electron micrographs of graphene-containing compositions are provided below. For example, FIG. 2A shows a detail view of a graphene-containing composition structure at a magnification in which the bar in the bottom line of the image represents 1 micrometer. Here, the graphene seen as ultra-thin and opaque layer is substantially contorted, while the areas where the sheet is folded and where the fold faces the observer is seen as white reflective lines/areas. A still higher magnification of the folded graphene structure is provided in FIG. 2B in which the bar in the bottom line of the image represents 100 nanometer.

While not limiting to the inventive subject matter, the inventors contemplate that the contortions in the graphene result in a strain in the sp² geometry, which is thought to change electronic properties in a manner similar to the known orbital strain in carbon nanotubes. Such strained geometry is thought to contribute to the unusually high binding capacity of contemplated compositions to numerous contaminants. Furthermore, similar to the known field emission of electrons in carbon nanotubes, the inventors contemplate that the edges of the graphene layers will act as an electron emitter for electrons of the graphene sheet under the influence of the electromagnetic microwave irradiation. Such high-energy electrons are then thought to contribute to the destruction of the contaminants bound to the graphene.

It should be recognized that formation of graphene using such reagents is particularly remarkable as “ . . . planar graphene itself has been presumed not to exist in the free state, being unstable with respect to the formation of curved structures such as soot, fullerenes, and nanotubes . . . ” [quoting Novoselov, K. S. et al. “Electric Field Effect in Atomically Thin Carbon Films”, Science, Vol 306, Issue 5696, 666-669, 22 Oct. 2004]. It should also be noted that micron-sized and larger graphite flakes have been previously prepared with a smallest dimension of at least several micrometers. However, such graphite flakes typically have an undesirable surface to volume ratio as well as a non-constrained surface (infra), and are therefore expressly excluded from the scope of the invention presented herein.

Depending on the starting material and conditions of manufacture, suitable compositions may therefore include between 0.1 vol % and 99.9 vol % of graphene. Based on other experiments (data not shown), contemplated compositions according to the inventive subject matter can also include single- and multi-walled carbon nanotubes, carbon nanohorns, and/or carbon nanoonions. Where such other nanostructures are present, it is typically preferred that the single- and multi-walled carbon nanotubes, carbon nanohorns, and/or carbon nanoonions are present in an amount of less than 50%, more preferably less than 30% and most preferably less than 10%. Thus, it is typically preferred that at least 50% of the nanostructured carbonaceous material is graphene.

Where desirable, it should be appreciated that contemplated compositions may be enclosed in a carrier that is permeable to at least the contaminant, and more typically also at least partially to the medium in which the contaminant is disposed. For example, where the medium is air and the contaminant is a chemical agent, contemplated compositions may be disposed within a filter housing. In another example, where the medium is water and the contaminant is a halogenated aromatic compound, contemplated compositions may be enclosed in a filter pad that is disposed in the water stream. Alternatively, the graphene-containing composition may also be injected into the flue gas stream and then collected (e.g., via electrostatic precipitation and/or filters).

Depending on the particular configuration, medium, and contaminant, it should be recognized that the binding and/or destruction of the contaminant may be performed in individual batches which are successively irradiated, or that the binding and/or destruction of the contaminant may be performed in a continuous (and most preferably on-line) fashion. Thus, it is particularly contemplated that the devices and methods of the inventive subject matter may be implemented in an air conditioning or ventilation system of a building or trailer in which incoming contaminated air is routed through the reaction chamber and graphene-containing composition. The contaminants then bind to the composition and are at least partially destroyed in the composition using microwave irradiation, and the so treated air is then provided to the building or trailer.

Consequently, the specific configuration of suitable devices may vary considerably, and the particular purpose of the device will predominantly determine the particular configuration. However, it is generally contemplated that the minimum configuration will include a reaction chamber that receives microwave radiation from one or more microwave sources, wherein the chamber includes the graphene-containing composition to which the contaminant is bound. Thus, contemplated devices may comprise one or more hermetically sealed reaction chambers, or a flow-through reaction chamber. In further preferred aspects, the reaction chamber is at least partially surrounded by a thermally insulating and/or refractory material that will allow high-temperature operation. For example, contemplated reaction chambers may include a ceramic mantle that at least partially encloses the reaction chamber. Still further, it is contemplated that the walls defining the reaction chamber may be coated or otherwise comprise the graphene-containing composition.

With respect to contaminants, it should be recognized that suitable contaminants can be readily identified by a person of ordinary skill in the art without undue experimentation. However, it is particularly preferred that contemplated contaminants include optionally substituted hydrocarbons (e.g., crude oil, refined hydrocarbons, chloroform, acteonitrile, benzene, toluene, xylene, etc.) and various chemical agents (e.g., soman, sarin, Vx, lewisite, and mustard gas). Depending on the specific nature of the contaminant, contemplated compositions will typically bind the contaminant in a non-covalent fashion in an amount that is at least 50-100% to the weight of the nanostructured material. However, and more typically, the contaminant will be bound in an amount of at least two times, more typically at least five times, even more typically at least twenty times, and most typically at least thirty times the weight of the nanostructured material. Thus, contemplated graphene-containing materials will include those comprising at least 10 wt % graphene and further comprising a chemical agent at a weight that is at least equal to a weight of the composition, more typically those comprising at least 30 wt % graphene wherein the chemical agent is present at a weight that is at least five times the weight of the composition, and most typically those comprising at least 90 wt % graphene, wherein the chemical agent is present at a weight that is at least twenty times the weight of the composition. Exemplary binding characteristics for selected contaminants are provided in the section entitled “Examples” below.

With respect to the microwave irradiation, it should be recognized that the particular frequency and/or energies may vary considerably. However, it is generally preferred that the frequency and energy is sufficient to cause electron emission from the graphene and/or to promote a rapid increase in temperature in the graphene-containing composition under microwave irradiation. Most conveniently, the microwave emitter is a commercially available magnetron with a microwave frequency of 2.45 GHz and power output between about 1500 W and 10000 W. There are numerous microwave emitters and associated control circuitry known and commercially available in the art (see e.g., Burle Electron Tubes, Panasonic Industrial Company, Inc.), and all of the known emitters and control circuitries are deemed suitable herein. Thus, suitable frequencies especially include those between 1-10 GHz, and suitable power output between 1 kW (and even less) and 50 kW (and more).

Preferably, the microwave emitter(s) is (are) disposed and arranged such that all or almost all of the radiation energy is delivered to the graphene-containing composition. Therefore, suitable emitters may be adjacent to the graphene-containing composition, and/or even partially or entirely disposed within the graphene-containing composition. Moreover, the number of microwave emitters may vary, and it should be recognized that a person of ordinary skill in the art will readily determine the best number and arrangement in the device without undue experimentation.

Thus, the inventors contemplate a method of destroying a contaminant in which in one step the contaminant is bound to a composition that includes at least 10 wt % graphene. In another step, the composition in which the contaminant is bound is then irradiated with an electromagnetic wave energy at a dose and wavelength effective to destroy the contaminant. Most preferably, the electromagnetic wave energy is microwave energy at a frequency and energy effective to cause electron emission from the graphene (e.g., between about 1-10 GHz and an energy of between about 1 kW and 50 kW). Preferred contaminants include optionally substituted hydrocarbons, optionally substituted polycyclic aromatic compounds, and various chemical agents. Most preferably, contemplated methods are implemented in a continuous mode operation in which the step of binding the contaminant and irradiating the composition is performed within an in-line unit that receives a gaseous influx from an upstream unit and that provides a gaseous efflux to a downstream unit. With respect to additional aspects and factors of such methods, the same considerations as provided above apply.

Thus, the inventors contemplate a composition comprising at least 10 wt % graphene, and an instruction associated with the composition that informs a person that the composition binds a chemical agent, and that microwave irradiation of the composition destroys the chemical agent. It should be appreciated that the instruction may be associated with the composition in many forms, and among other forms of association, it is especially preferred that the instructions are provided together with the composition, or with a description of the composition in a catalog or other sales document. Furthermore, it should be recognized that the information may be provided in printed form (typically in form of a written description), displayed form (e.g., on a website), or in audible form (e.g., via oral description), and all known manners of providing such information are deemed suitable for use herein. It is also contemplated that the information further includes an information that the microwave irradiation has a frequency and energy sufficient to cause electron emission from the graphene. Again, with respect to further aspects and factors, the same considerations as provided above apply. Further aspects, compositions, methods, and uses are disclosed in our commonly owned copending U.S. applications with the title “Compositions and Methods for Gas and liquid Purification” (filed Dec. 7, 2004) and “Mass Production Of Carbon Nanostructures” (filed Dec. 7, 2004), both of which are incorporated by reference herein.

### EXAMPLES

The following examples are provided only to illustrate selected aspects of the inventive subject matter and are not limiting to the inventive concept presented herein.

### Production of Graphene-Containing Composition

1 g of flake graphite (e.g., commercially available from Superior Graphite Company, 10 South Riverside Plaza, Chicago, Ill. 60606, or Crystal Graphite Corp., Vancouver, B.C., Canada) was admixed with 1 ml activated acid catalyst (e.g., Activated Acid Catalyst #3, commercially available from SupraCarbonic, 348 N. Eckhoff Street—Orange, Calif. 92868, USA) and briefly heated to expansion at 100° C. to about 200° C. The material was subsequently used without further purification.

### Sorption Capacity for Selected Contaminants

Table 1 provides an exemplary listing of sorption capacity of contemplated materials as compared to commercially available granulated activated charcoal. All values in the table reflect gram contaminant absorbed per gram of contemplated materials/granulated activated charcoal. In this series of experiments, the listed contaminants were contacted with the tested materials to saturation and the saturated materials were weighed. GRP is graphene-containing composition (here: >80% graphene), GAC is activated charcoal, and Ratio is expressed in fold amount sorption capacity of GRP over GAC.

TABLE 1

| Contaminant | GRP | GAC | Ratio |
|---|---|---|---|
| Sarin | 36.97 | 1.46 | 25 |
| Soman | 27.75 | 6.93 | 4 |
| Vx | 28.64 | 0.58 | 49 |
| Mustard Gas | 36.73 | 1.7 | 21 |
| Lewisite | 51.82 | 2.0 | 26 |

### Contaminant Destruction Using Microwave Irradiation

In this example, 1 gram of GRP was loaded to about 20% sorption capacity for the indicated chemical agent, placed in a sealed ceramic container and irradiated using 2.45 GHz microwave radiation at approximately 500 W for 20 seconds. The ceramic container was then swept with nitrogen and the sweep gas and GRP was tested for remaining chemical agents. All values are given as concentrations in g/g and are listed in Table 2. ND is non detectable.

TABLE 2

| Contaminant | Before (GRP) | After (GRP) | After (Sweep Gas) |
|---|---|---|---|
| Sarin | 7.2 | ND | ND |
| Soman | 5.4 | ND | ND |
| Vx | 5.6 | ND | ND |
| Mustard Gas | 7.2 | ND | ND |
| Lewisite | 10.2 | ND | ND |

Thus, specific embodiments and applications of compositions and methods for binding and in situ destruction of chemical agents have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. A reactor comprising:
a microwave transmitter that is coupled to a reaction space such that microwave radiation from the microwave transmitter is delivered to the reaction space; and
a composition comprising at least 10 wt % graphene, wherein a contaminant is bound to the composition, and wherein the composition is disposed within the reaction space.

2. The reactor of claim 1 wherein the microwave transmitter is configured to operate at a frequency and energy sufficient to cause electron emission from the graphene.

3. The reactor of claim 1 further comprising a thermal insulator that is coupled to the reaction space.

4. The reactor of claim 1 further comprising an inlet and an outlet fluidly coupled to each other via the reaction space such that a gaseous medium containing the contaminant enters the reaction space through the inlet and such that gaseous medium depleted of the contaminant exits the reaction space through the outlet.

5. The reactor of claim 4 wherein the reactor is configured for continuous operation in which the gaseous medium containing the contaminant enters the reaction space as the gaseous medium depleted of the contaminant exits the reaction space.

6. The reactor of claim 1 wherein the contaminant is a chemical agent selected from the group consisting of soman, sarin, Vx, lewisite, and mustard gas.

7. A composition comprising at least 10 wt % graphene, and an instruction associated with the composition that informs a person that (a) the composition binds a chemical agent, and (b) that microwave irradiation of the composition destroys the chemical agent.

8. The composition of claim 7 wherein the information further includes an information that the microwave irradiation has a frequency and energy sufficient to cause electron emission from the graphene.

9. The composition of claim 7 comprising at least 80 wt % graphene, and wherein the chemical agent is selected from the group consisting of soman, sarin, Vx, lewisite, and mustard gas.

10. A composition comprising at least 10 wt % graphene and further comprising a chemical agent at a weight that is at least equal to a weight of the composition.

11. The composition of claim 10 comprising at least 30 wt % graphene, and wherein the chemical agent is present at a weight that is at least five times the weight of the composition.

12. The composition of claim 10 comprising at least 90 wt % graphene, and wherein the chemical agent is present at a weight that is at least twenty times the weight of the composition.

13. A method of destroying a contaminant, comprising a step of binding the contaminant to a composition that includes at least 10 wt % graphene, and another step of irradiating the composition with electromagnetic wave energy at an energy and wavelength effective to destroy the contaminant.

14. The method of claim 13 wherein the step of binding the contaminant comprises contacting the composition with a gaseous medium that comprises the contaminant.

15. The method of claim 14 wherein the gaseous medium is passed through the composition, and wherein the step of binding and the step of irradiating are performed while the gaseous medium passes through the composition.

16. The method of claim 13 wherein the electromagnetic wave energy comprises microwave irradiation at a frequency and energy sufficient to cause electron emission from the graphene.

17. The method of claim 13 wherein the contaminant is an optionally substituted hydrocarbon, or an optionally substituted polycyclic aromatic compound.

18. The method of claim 13 wherein the contaminant is a chemical agent.

19. The method of claim 18 wherein the chemical agent is selected from the group consisting of soman, sarin, Vx, lewisite, and mustard gas.

20. The method of claim 13 wherein the step of binding the contaminant and irradiating the composition is performed within an in-line unit that receives a gasesous influx from an upstream unit and provides a gaseous efflux to a downstream unit.
